(19) United States
(12) Patent Application Publication
(10) Pub. No.: US 2005/0210631 A1
(43) Pub. Date: Sep. 29, 2005

(54) Hinge

(76) Inventor: Joseph Anscher, Muttontown, NY (US)

Correspondence Address: WILLIAM COLLARD;COLLARD & ROE, P.C., 1077 NORTHERN BOULEVARD, ROSLYN, NY, 11576, US

(21) Appl. No.: 11/121,643

(22) Filed: May 4, 2005

Related U.S. Application Data
(63) Continuation-in-part of application No. 10/453,949, filed on Jun. 4, 2003.

(51) Int. Cl. B29C 45/00

(52) U.S. Cl. 16/386; 264/328.1; 264/334

(57) ABSTRACT

A hinged product has a first section and a second section. The first section has a post extending transversely across one end thereof. The second section two co-axial apertures therein, each of the apertures having an internal wall. The post extends between and through the apertures to connect the first section to the second section. There is at least one protrusion located on either the post or the internal walls of the apertures. There is at least one rib disposed the other of the internal walls or the post. The rib contacts the protrusion as the second section is rotated relative to the first section and causes resistance to rotation. This resistance allows for a stepped rotation of the two sections relative to one another. The product is integrally molded in one piece via a molding gate that is offset from a parting line of the mold. When the mold is opened, the mold shears off the molding gate to create a two-piece clip.

### CROSS REFERENCE TO RELATED APPLICATIONS

This is a continuation-in-part of U.S. patent application Ser. No. 10/453,949 filed on Jun. 4, 2003.

### BACKGROUND OF THE INVENTION

1. Field of the Invention

The invention relates to a hinge that is suitable for many uses, but is particularly suitable for use in rod clips that hold metal rods inside the door mechanisms of automobiles. In particular, the invention relates to a hinge that can be molded in one piece and subsequently snapped into two pieces for use.

2. The Prior Art

It is well known in the automotive industry to use rod clips to connect actuating rods to levers. This type of arrangement is especially common with door locking mechanisms and carburetor linkage arrangements. The clips are typically made of a plastic material and snap around the end of the rod. The lever is then snapped into a protrusion on the clip having a retaining lip or latches on its sides.

The clips can be manufactured as one piece with an integral “living hinge” or in two pieces with a connection mechanism connecting the two pieces. In general, the two-piece constructions are more durable, but can be difficult to mold and assemble because of the separate pieces.

In addition, the two-piece hinges generally have a lot of play between the two parts, and the interaction between the two parts is very loose.

It would be desirable to construct a rod clip or other item having a two-piece hinged construction that can be molded in one step, not require assembly, and which can have a varying amount of resistance between the two pieces to satisfy different requirements.

### SUMMARY OF THE INVENTION

The invention comprises a hinged product having a first section and a second section. The first section has a post extending transversely across one end. The second section has two co-axial apertures therein, each of the apertures having an internal wall. The post on the first section extends through the apertures in the second section to connect the first section to the second section.

The first section is integrally formed with the second section via at least one molding gate. This molding gate is located offset from a center line of the mold during the molding process, so that when the hinged product is ejected from the mold, the mold shears off the molding gate, and a two-piece hinged product remains. Thus, a two-piece hinge can be manufactured in a single mold.

In an alternative embodiment, the first and second sections are molded as separate pieces, with each of the first and second sections having their own molding gates. These molding gates are also located below a parting line of the mold, so that when the mold is opened, the molding gates are sheared off.

The hinge according to the invention is useful in many different products. It is particularly useful in a rod clip, such as that shown in U.S. patent application Ser. No. 10/768,763, the disclosure of which is herein incorporated by reference.

In a preferred embodiment, the post and aperture could have a plurality of ribs and protrusions, creating a stepped-like rotation between the two sections. This feature is disclosed in U.S. patent application Ser. No. 10/453,949, which is herein incorporated by reference.

The product according to the invention could be formed of any suitable material, such as injection-molded plastic.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a perspective view of a first embodiment of the hinge according to the invention;

FIG. 2 shows an enlarged side view of the hinge according to FIG. 1;

FIG. 3 shows a side view of the embodiment of FIG. 2, with the hinge rotated 90 degrees;

FIG. 4 shows a cross-sectional view of the post and aperture arrangement of FIG. 3;

FIG. 5 shows a side perspective view of an alternative embodiment of the hinge according to the invention;

FIG. 6 shows an enlarged side view of the hinge of FIG. 5;

FIG. 7 shows a top view of the hinge according to the invention, showing a parting line of the mold;

FIG. 8 shows an enlarged cross section of the molding gate formed during the molding process, along with a parting line of the mold; and

FIG. 9 shows a cross section of an alternative embodiment of the invention, where each of the first and second sections have separate molding gates.

### DETAILED DESCRIPTION OF THE PREFERRED EMBODIMENT

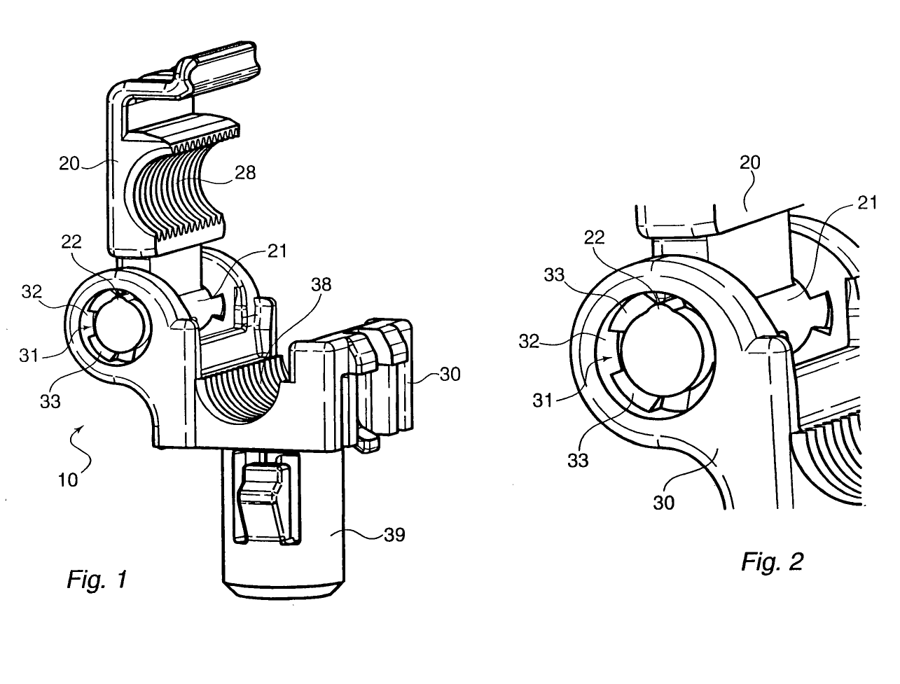

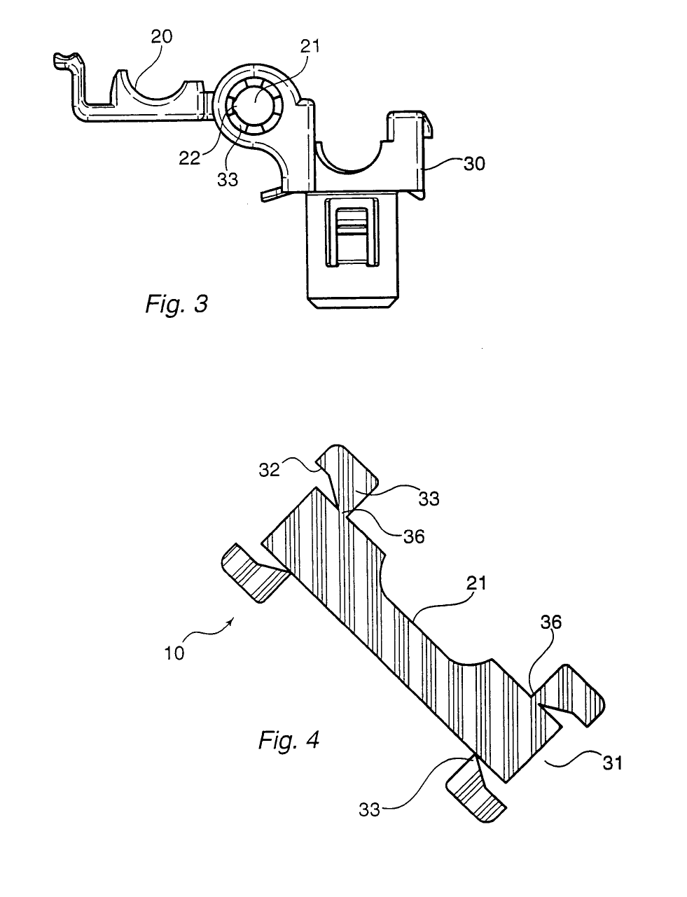

Referring now in detail to the drawings, FIGS. 1-3 show a preferred embodiment of the hinge according to the invention, as it is used on a rod clip 10. Rod clip 10 comprises a first section 20 that is hinged to a second section 30. First section 20 has a rod 21 that extends through two co-axial apertures 31 on second section 30. Rod 21 has a rib 22 extending longitudinally along its surface. Each aperture 31 has an inside wall 32 extending all around. Along inside wall 32 are a plurality of protrusions 33. As first section 20 is rotated relative to second section 30, rib 22 abuts protrusions 33 and resists the rotation. This way, the product can be placed in one of several different uniform orientations. Excess force is required to rotate the hinge beyond a resting position, because rib 22 must be forced past its adjacent protrusion 33. By varying the number and position of ribs 22 and protrusions 33, one can create a customized hinge having an unlimited variety of indexing positions. In the embodiment shown in FIGS. 1-3, there are four protrusions, and two different indexing positions are shown. In FIG. 1, first section 20 is placed perpendicular to second section 30. In FIG. 3, first section 20 is located parallel with second section 30. In an alternative embodiment, the protrusions are arranged around the ends of post 21 and the rib extends along inner wall 32, creating the same interaction between protrusions and rib as described above.

In a preferred embodiment, as shown in cross-section in FIG. 4, the entire rod clip 10 or other product is molded integrally as one piece, with connection points 36 connecting first section 20 to second section 30. Connection points 36 extend out from protrusions 33 located on inner wall 32 of aperture 31, and connect directly to post 21 on second section 20. This way, a single mold is required to mold the entire product. To use the hinge, connection points 36 are broken by rotating first section 20 relative to second section 30 until connection points snap. Then, the two sections are permanently separated from each other and function as a two-piece hinge.

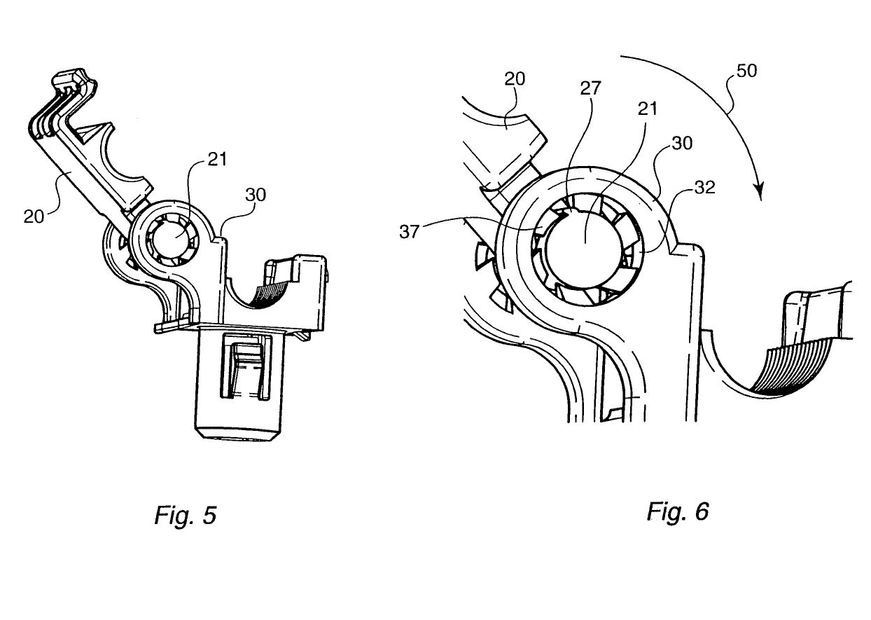

In an alternative embodiment shown in FIGS. 5 and 6, rib 27 and protrusions 37 function form a ratchet, allowing rotation of the hinge in only one direction. This occurs because rib 27 is formed into a curved shape while protrusions 37 are angled toward the curved tip of the rib, so that rib 27 and protrusions 37 interact and protrusions 37 cannot be bypassed in one direction. First section 20 can rotate around second section 30 only in the direction of arrow 50.

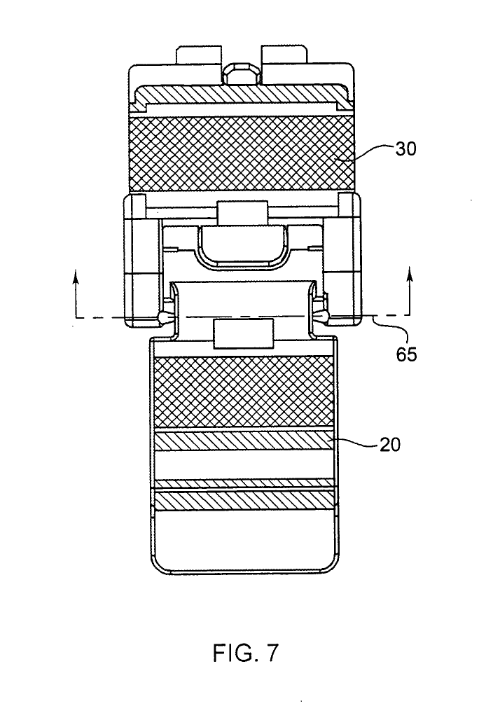

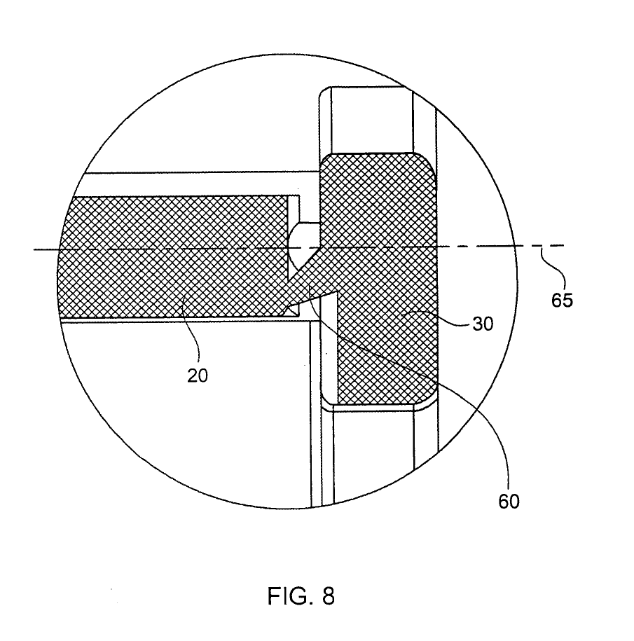

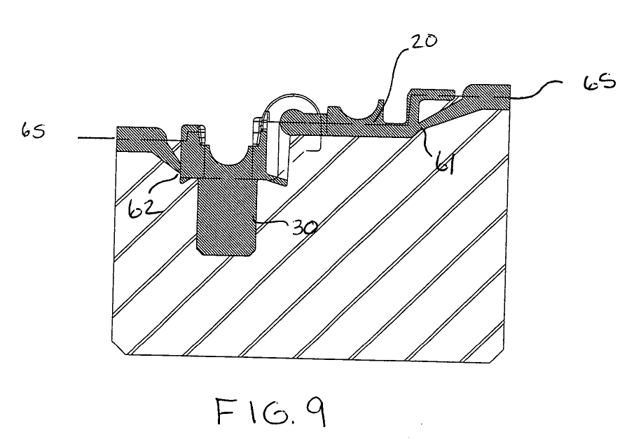

FIGS. 7 and 8 show details of the hinge as it is created during the molding process. A molding gate 60 is formed between the first section 20 and the second section 30, so that rod clip 10 can be formed in one piece with one mold. Molding gate 60 is sheared off by the metal of the mold as it opens, due to the fact that molding gate 60 lies offset from a parting line 65 of the mold. Thus, rod clip 10 is released from the mold as a two-piece clip, even though it is initially molded in one piece. This saves the user from having to break the molding gate himself during operation.

The ribs and protrusions allow clip 10 to be placed in any desired position, so that an intact molding gate is not required for shipping or initial placement.

FIG. 9 shows an alternative embodiment of the invention, where each of the first and second sections 20, 30 are formed via separate molding gates 61, 62. First and second sections 20, 30 are molded in two separate pieces via these separate molding gates. Molding gates 61, 62 are also located below the parting line 65 of the mold, so that when the mold is open and the parts are ejected, molding gates 61, 62 break as well.

Accordingly, while only a few embodiments of the present invention have been shown and described, it is obvious that many changes and modifications may be made thereunto without departing from the spirit and scope of the invention.

1. A hinged product comprising:
a first section having a post extending transversely across one end thereof;
a second section having two co-axial apertures therein, each of said apertures having an internal wall, wherein the post on the first section extends through the apertures in the second section to connect the first section to the second section;
at least one protrusion located on one of the post and the internal walls of the apertures; and
at least one rib disposed on one of the apertures and the post, said rib contacting said at least one protrusion as the second section is rotated relative to the first section and causing resistance to rotation,
wherein the first section and the second section are formed in a mold via at least one molding gate, said molding gate being located at a point below a parting line of a mold that forms the hinged product, such that when said mold is opened and said product ejected from the mold, the mold breaks the molding gate during ejection.

2. The hinged product according to claim 1, wherein the at least one protrusion is located on the aperture and the at least one rib is disposed along the post.

3. The product according to claim 1, wherein the apertures have a plurality of protrusions.

4. The product according to claim 3, wherein the first section can be placed in a selected one of several positions relative to the second section, by rotating the first section relative to the second section to a point where the rib rests between two of the protrusions.

5. The product according to claim 3, wherein the protrusions and the rib form a ratchet mechanism such that the first section rotates relative to the second section in only one direction.

6. The product according to claim 1, wherein the product is a rod clip.

7. The product according to claim 1, wherein the product is formed of injection-molded plastic.

8. The product according to claim 1, wherein there are four protrusions.

9. The product according to claim 1, wherein there are a plurality of ribs.

10. The product according to claim 1, wherein the molding gate is formed between the first and second sections, and connects them, and wherein when the first and second sections are ejected from the mold, the molding gate is broken and the first and second sections are separated from each other.

11. The product according to claim 1, wherein the first and second sections are molded via separate molding gates.

12. A method for forming a hinged product having the following features:
a first section having a post extending transversely across one end thereof;
a second section having two co-axial apertures therein, each of said apertures having an internal wall, wherein the post on the first section extends through the apertures in the second section to connect the first section to the second section;
at least one protrusion located on one of the post and the internal walls of the apertures; and
at least one rib disposed on one of the apertures and the post, said rib contacting said at least one protrusion as the second section is rotated relative to the first section and causing resistance to rotation, the method comprising the following steps:
injecting molten plastic into a mold having cavities arranged to form the first and second sections; and
opening the mold and ejecting the finished hinge, wherein said first and second sections are molded via at least one molding gate located offset from a parting line of the mold, such that said step of opening the mold and ejecting the finished hinged product causes the molding gate to break.

13. The process according to claim 12, wherein the molding gate connects the first and second section, such that opening the mold separates the first section from the second section.

14. The process according to claim 12, wherein the first and second sections are formed via separate molding gates.
